(19) United States
(12) Patent Application Publication
(10) Pub. No.: US 2014/0180609 A1
(43) Pub. Date: Jun. 26, 2014

(54) METHOD OF ESTABLISHING THE DEFLECTION AND/OR THE STIFFNESS OF A SUPPORTING STRUCTURE

(71) Applicant: EBER DYNAMICS, Falun (SE)

(72) Inventor: Eric Berggren, Falun (SE)

(73) Assignee: Eber Dynamics, Falun (SE)

(21) Appl. No.: 14/118,567

(22) PCT Filed: Apr. 25, 2012
(86) PCT No.: PCT/SE2012/050432

§ 371 Date: Nov. 19, 2013

(30) Foreign Application Priority Data
May 19, 2011 (SE) 1150470-1

(51) Int. Cl. G01N 3/40; G01N 3/20; E01B 35/12

(52) U.S. Cl. CPC G01N 3/40; E01B 35/12; G01N 3/20
USPC 702/42

(57) ABSTRACT

A method for establishing the deflection and/or the stiffness of a supporting structure which is subjected to a load. The method includes the steps of moving a measurement vehicle along the supporting structure, the vehicle having a loaded axle, a first measuring system being a first versine system and a second measuring system being one of an inertia based system and a second versine system. At a predetermined sampling rate, two sets of levels are measured using the two measuring systems. The two sets of levels are converted or transformed such that they relate to the same reference system and, thereafter, for each pair of sampled levels, the difference between the two levels is calculated such that the contribution to the measurements originating from unloaded irregularities in the supporting structure is eliminated, whereafter the deflection and/or the stiffness of the supporting structure is established from the calculated difference.

The present invention relates to a method for establishing the deflection and/or the stiffness of a supporting structure which is subjected to a load.

In the following and unless otherwise stated, the term “supporting structure” is understood to comprise the total supporting structure of a road, an airfield runway or taxiway or a railway track, or any other corresponding supporting structure which is subjected to recurrent loads from vehicles. The term “supporting structure” comprises the structure from the subgrade to and including the surface layer of the road, the airfield runway or taxiway or, in the case of a railway, the railway track.

In particular, the present invention relates to, but is not restricted to, using the measured level to estimate the stiffness of the supporting structure, and in particular the vertical stiffness of a railway track.

For supporting structures of the above-mentioned type, it is of interest to know how the supporting structure reacts to loads, and in particular to loads travelling over the supporting structure. Conventionally, the deflection of a supporting structure due to a travelling load is established by letting a measuring vehicle having two differently loaded axles travel over the supporting structure and measuring the level of the supporting structure at the two axles. By comparing the level values at the two axles, the deflection of the supporting structure can then be estimated. Alternatively, the deflection can be estimated directly by using measuring vehicles having specialized laser-doppler equipment. However, these methods of establishing the deflection of a supporting structure requires highly specialized measuring vehicles and, therefore, cannot be generally applied by infrastructure managers or maintenance companies.

The stiffness of a supporting structure is defined as the coefficient of proportionality between a load applied to the supporting structure and the deflection of the same. The applied load may for example be a travelling train. The stiffness is an accepted indicator of the quality and structural integrity of supporting structures of the above-mentioned types. Consequently, there is a need to recurrently measure the stiffness of such supporting structures to ensure the safety of usage of the supporting structures as well as to plan for maintenance work on the supporting structures. The modulus and the stiffness of a supporting structure are closely related and are often used to describe similar properties.

In principle, the stiffness of a supporting structure is estimated by measuring the deflection of the supporting structure when the supporting structure is subjected to a measured or estimated load, e.g. a travelling load.

The surface of a supporting structure is never completely smooth. Irregularities are always present. Level, alignment, irregularities and surface are examples of different terms describing vertical deviation from a perfectly smooth surface of a supporting structure. For a railway also the lateral irregularities are of interest. In the following and unless otherwise stated, the term “level” will be used to describe deviations from a perfectly smooth surface of a supporting structure.

As far as measuring the level of a supporting structure of the above-mentioned type, a number of techniques are known.

For railways there exist both dedicated track recording cars whose only purpose is to measure track geometry quality (and other parameters as well) and the same kind of systems, although automated, can be found mounted on ordinary trains. Almost all railway networks are monitored at some frequency. Normal frequencies range from twice per year up to once every week. The main purpose of such measurements is to find geometrical defects that causes the train to run unsafe or with less comfort. The measurements are also naturally used to plan maintenance in order to rectify geometrical defects in the track.

Measurements of roads are most commonly made using dedicated measurement vehicles having a laser beam and an inertia unit combination mounted in front of or at the rear of the vehicle.

For railways there are mainly two types of systems in use for measuring the level of the railway track. These systems are partly described in the standard EN13848 on railways.

The first system is a versine (versed sine) or chord based measurement system. In this system the level of the railway track is measured with a three-point chord (sometimes more points), normally with the central point under a fully loaded axle. The chord track geometry is taken from the offset measured at an intermediate point from a straight-line chord. The offset is measured in relation to a reference point, which can be given by the body of the vehicle, if it is stiff enough, or, if not, by compensating for its movement. In the latter case, the compensation can be obtained by measuring the body behaviour in bending and twisting relatively to an external and absolute reference, e.g. a laser beam. The sensors can be of the contact or the non-contact type. Normally, contact measurement sensors use the wheels in the vertical direction and specific sensors, like trolleys or rollers, in the lateral direction.

Non-contact measurements are often based on lasers.

A chord-based system will distort measured irregularities by a transfer function. For example, a symmetric chord measurement system with the geometry of 5+5 metres, i.e. having one measuring point arranged 5 metres in front of the loaded axle and one measuring point arranged 5 metres behind the loaded axle, will measure a harmonic irregularity with a wavelength of 10 metres and an amplitude of 5 mm as having an amplitude of 10 mm. As another example, a harmonic irregularity with a wavelength of 5 metres and an amplitude of 5 mm will be measured as having an amplitude of 0 mm (zero-point). Chord-based systems, and especially asymmetric chord measurements, can be corrected by known techniques.

The second type of system is based on inertia sensors, e.g. accelerometers and/or gyros, sometimes in combination with optical sensors, e.g. lasers, and/or displacement transducers. Inertia measurements do not suffer from any transfer function distortion. For roads, measurements are often performed with a beam having a plurality of lasers and an inertia unit. The road is thereby characterized longitudinally as well as transversally. Road measurements are not necessarily done nearby a loaded axle, whereas railway measurements are always done at or close to a loaded axle.

There are methods that use level measurements as a basis for retrieving the stiffness of a railway track. Such known systems use two axles which are differently loaded and measure the level resulting from each loaded axle. The stiffness of the railway track is then calculated from the measured level values, which are different for the two axles due to the different loads. For example, U.S. Pat. No. 6,405,141 B1 discloses such a method.

U.S. Pat. No. 6,119,353 A discloses a method for non-contact measurement of the deflection of a road. The method utilizes equipment comprising a self-propelled vehicle with a load which influences at least one wheel, the speed of which is measured in the direction of travel. The equipment further comprises a laser device from which at least one electromagnetic beam is directed towards the roadway in the vicinity of the vehicle, and the Doppler frequency change in the reflection is detected. An electronic circuit continuously registers the results of the measurements and herewith the deflection at normal travelling speed.

U.S. Pat. No. 7,403,296 B2, US 2006/0144129 A1, U.S. Pat. No. 7,755,774 B2 and US 2008/0228436 A1 disclose a non-contact measurement system for measuring the vertical stiffness of a railway track directly. The system comprises first and second optical emitters which are mounted to a measuring vehicle and configured to emit beams of light that are detectable on the underlying surface. A camera is mounted to the vehicle for recording the distance between the beams of light as the vehicle travels along the surface. The distance between the beams of light, which is a function of the surface stiffness, is then measured using image recognition techniques.

U.S. Pat. No. 5,756,903 A discloses a motor vehicle body which is adapted for measuring the horizontal and lateral strength of railroad tracks. The vehicle comprises a loaded gage axle assembly having vertical loads imposed by hydraulic rams, and horizontal loads being supplied by horizontal rams through split axles and steel wheels to the railroad tracks is calibrated to measure track strength and adapted to be operatively connected to electronic data recording and comparing apparatus.

However, as is the case with known deflection measuring systems, a problem with the known systems for measuring the stiffness directly is that they are quite complex and require specialized measurement vehicles.

The objective of the present invention is to solve this problem and produce a method for deflection measurements which can be implemented using existing geometry measuring vehicles with no or very limited modifications, and which method can easily be expanded to encompass stiffness measurements.

The method according to the invention utilizes a measuring vehicle comprising:
a loaded axle,
a first measuring system being a versine system comprising at least a first reference point at a predetermined first position in relation to the loaded axle, a second reference point at a predetermined second position in relation to the loaded axle and a third reference point at a predetermined third position in relation to the loaded axle, and
a second measuring system being one of:
   an inertia based system which is fitted on the loaded axle, and
   a versine system comprising at least a first reference point at a predetermined first position in relation to the loaded axle, a second reference point at a predetermined second position in relation to the loaded axle and a third reference point at a predetermined third position in relation to the loaded axle, wherein the position of at least one of the reference points of the two versine systems is unique to one of the versine systems;

The method according to the invention comprises the steps of:
moving the measurement vehicle along the supporting structure such that the loaded axle creates a deflection bowl in the supporting structure and such that at least one of the reference points of the first measuring system and at least one of the reference points of the second measuring system is within the deflection bowl;
at a predetermined sampling rate, measuring a first set of first levels of the supporting structure using the first measuring system and a second set of second levels of the supporting structure using the second measuring system;
converting or transforming at least one of the sets of levels such that the two sets of levels relate to the same reference system and, thereafter, for each pair of sampled levels, calculating the difference between the measured first level and the measured second level, thereby eliminating the contribution to the measurements originating from unloaded irregularities in the supporting structure; and
from the calculated difference, establishing the deflection and/or the stiffness of the supporting structure.

The method according to the invention is based on the fact that a level measurement of a supporting structure being subjected to a loaded axle comprises two parts. The first part relates to level variations due to irregularities present in the unloaded supporting structure and the second part relates to the extra deflection which is due to the loaded axle.

The first measuring system, being a versine system, has reference points at, in front of and behind the loaded axle. The second measuring system, if it is a versine system, also has reference points at, in front of and behind the loaded axle, but at least one of the reference points of the two versine systems is unique to one of the versine systems, i.e. there is at least one reference point which belongs to only one of the versine systems.

An inertia system fitted on the loaded axle will measure the level of the supporting structure at the position of the loaded axle. In other words, the reference point of the inertia system can be said to be at the loaded axle and, consequently, the reference points of the versine system of the first measuring system which are not at the loaded axle will be unique to the first measuring system.

Consequently, at least one of the two measuring systems will have at least one reference point which is unique to that measuring system.

The contribution to the measured level originating from unloaded irregularities in the supporting structure will be identical in the two measurements. Consequently, the difference between two measurements having different reference points will only relate to the deflection or bending of the supporting structure due to loading. This difference can be described using a beam equation in which the governing parameter is the stiffness. Hereby, the stiffness of the supporting structure can be found continuously along the length of the supporting structure.

Depending on the type of supporting structure and the load of the axle, the deflection profile caused by the loaded axle, which is commonly referred to as the deflection bowl, will normally have an elongation in the range of metres. Consequently, at least one of the reference points of the first measuring system and at least one of the reference points of the second system is within the deflection bowl, i.e. is located inside the deflection bowl, e.g. at the loaded axle. In this context, “at the loaded axle” is understood to mean within the vicinity of the loaded axle, e.g. within 0-0.5 m from the loaded axle.

A versine system often has its central reference point at the position of the loaded axle and one or a plurality of reference points on either side of the loaded axle. A commonly used configuration of the versine system is the three point versine system, which has a central reference point at the position of the loaded axle and one reference point on either side of the loaded axle, which later reference points define the chord positions of the versine system and may be inside or outside of the deflection bowl.

The inertia system is mounted on the loaded axle and, consequently, has its reference point inside of the deflection bowl.

According to one configuration of the method of the invention, the first measuring system comprises a three point versine system having one reference point at the loaded axle and one reference point on either side of the loaded axle inside of the deflection bowl, and the second measuring system comprises an inertia system mounted on the loaded axle. The inertia system will measure the level of the supporting structure at the position of the loaded axle, whereas the versine system will have its reference points defining the chord positions in not fully loaded areas, in which areas the level of the supporting structure will be higher than in the fully loaded area. For a railway track, the level difference between the fully loaded area and the not fully loaded areas may for example be between 0.1 mm and 2 mm. For a road surface, the level difference may be slightly less.

According to an alternative configuration of the method, three point versine systems are used in both measuring systems, wherein the first versine system has a central reference point at the loaded axle and one reference point on either side of and close to the loaded axle, i.e. within the deflection bowl, and wherein the second versine system has a central reference point at the loaded axle and one reference point on either side of but further away from the loaded axle and preferably outside of the deflection bowl. In order to simplify installation, one or two of the reference points defining the chord positions could be the same for the two versine systems. In order to establish two three point versine systems, at least four chord positions are needed. If e.g. five chord positions are used, four different chords could be established having the same central reference point, or centre point, enabling redundancy and better accuracy in the estimation of the stiffness.

Since measuring vehicles having either an inertia based measuring system or a versine based measuring system are commonly in use, it is easy to realise a measuring vehicle suitable for collecting the data required by the present model simply by adding the missing second measuring system to a conventional measuring vehicle.

In the following, as an example of the method according to the invention, the measurement of the vertical deflection and the stiffness of a railway track will be described in more detail with reference to the appended drawing, wherein:

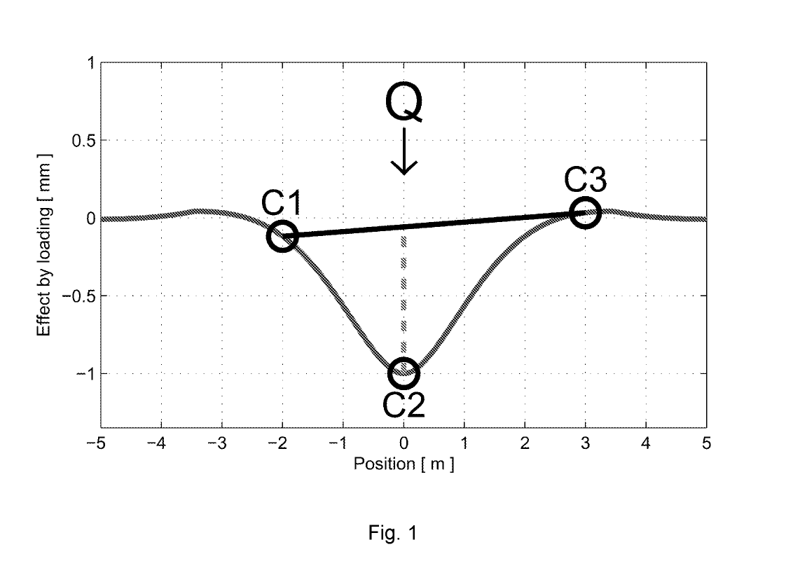

FIG. 1 schematically discloses a three point versine measuring system operating inside the deflection bowl of a railway track.

According to the method, a measurement vehicle having a loaded axle is brought to travel along the railway track. The vehicle comprises two measuring systems, which are brought to measure the vertical level of the track at a suitable sampling rate, which preferably is within the interval of 2 to 20 samples per metre.

The first measuring system is a three point versine measuring system having a first reference point C1 2 metres behind the loaded axle, a second reference point C2 at the loaded axle and a third reference point C3 3 metres in front of the loaded axle, as is disclosed in FIG. 1. In other words, the first measuring system is a 2+3 metre versine system.

The second measuring system is an inertia based measuring system which is fitted on the loaded axle.

The second measuring system, i.e. the inertia based system, will directly yield the loaded level of the railway track, i.e. the loaded track irregularities along the length of the track. The first measuring system, i.e. the versine system, is distorted by a transfer function. In order to be able to compare measurements from the two measuring systems, both measuring systems need to refer to the same reference system. Either the versine based measured data can be rectified by an inverse transfer function, or the inertia based measured data can be transferred as to have the same reference as the versine measurement.

As discussed above, the measured level comprises a first part, which relates to level variation due to irregularities present in the unloaded railway track, and a second part, which relates to the extra deflection due to the loaded axle.

Consequently, the measurement from the second measuring system, i.e. the inertia based system, can be expressed as:

s_{In}(x)=s_{L}(x)=s_{U}(x)+w(x,x) Eq. 1

where s_{In}(x) is the level measured with the inertia measuring system, s_{L}(x) is the loaded level, s_{U}(x) is the unloaded level and w(x,x₁) is the contribution to the measured level due to the loaded axle with the load in position x₁ (x and x₁ are equal in the equation above).

As is known in the art, a three point versine system will transfer or distort the measured level according to the following equation:

s_{C}_{_{—}}_{I}(x)=s_{In}(x)−(bs_{In}(x+a)+as_{In}(x−b))/l Eq. 2

where the three reference points of the versine measuring system are in the positions x−b, x and x+a and where l=a+b.

In order to compare the measurements from the inertia based system and the versine system, the level measurements of the inertia based system are converted to the same reference system as the versine system by substituting Eq. 1 into Eq. 2 such that:

s_{C}_{_{—}}_{I}(x)=s_{U}(x)−(bs_{U}(x+a)+as_{U}(x−b))/l+w(x,x)−(bw(x+a,x+a)+aw(x−b,x−b))*l Eq. 3

Alternatively, as has been discussed above, the versine system may be rectified such that it refers to the reference system of the inertia based system.

The versine system has its central reference point C2 at the loaded axle. If the reference points C1 and C3 are inside the deflection bowl, the reference points C1 and C3 are not fully loaded, but are only partly influenced by the load at C2. This can be expressed as:

$${s}_{C} ( x ) = {s}_{L} ( x ) - ( b ( {s}_{U} ( x + a ) + w ( x + a , x ) ) + a ( {s}_{U} ( x - b ) + w ( x - b , x ) ) / l == {s}_{U} + w ( x , x ) - ( b ( {s}_{U} ( x + a ) + w ( x + a , x ) ) + a ( {s}_{U} ( x - b ) + w ( x - b , x ) ) / l \qquad Eq . 4$$

Consequently, the difference between the two systems, i.e. s_{C}_{_{—}}_{I}(x)−s_{C}(x), will only be a function of the contribution from the loaded axle and not of the level such that:

s_{C}_{_{—}}_{I}(x)−S_{C}(x)==(b(w(x+a,x)−w(x+a,x+a))+a(w(x−b,x)−w(x−b,x−b)))/l Eq. 5

The contribution to the measured level originating from unloaded irregularities in the railway track is thereby eliminated, as has been described above, and the calculated difference will only be related to the displacement of the railway track due to the reference points C1 and C3 of the first measuring system.

Consequently, the method according to the invention comprises the step of, for each pair of measured level values, calculating the difference between the first level, i.e. the level measured using the first measuring system, and the second level, i.e. the level measured using the second measuring system, such that the contribution to the measurements originating from unloaded irregularities in the railway track is eliminated.

If the reference points C1 and C3 are outside the deflection bowl, i.e. if the positions x+a and x−b are outside the deflection bowl, w(x+a,x) and w(x−b,x) are zero. In this case the difference between the two level measurements can be related to the load induced deflection without having to assume anything about the shape of the deflection bowl. In this case, the deflection of the railway track at the loaded axle can be estimated from Eq. 5 directly. Approximately, the deflection is equal to

$$w ( x , x ) = {s}_{C\_I} ( x ) - {s}_{C} ( x ) = \\ = - ( bw ( x + a , x + a ) + aw ( x - b , x - b ) ) / l \qquad Eq . 6$$

Preferably, however, the deflection is estimated by an inverse filter described by the z-transform as in Eq. 7.

$$H ( z ) = \frac{- 1}{\frac{b}{l} {z}^{{af}_{s}} + \frac{a}{l} {z}^{- {bf}_{s}}} \qquad Eq . 7$$

where H(z) is the inverse transfer function and fₛ is the chosen sampling frequency.

Consequently, if the first reference point C1 and the third reference point C3 of the first measuring system are arranged outside of a deflection bowl generated by the loaded axle, the deflection of the supporting structure can be estimated directly from the difference between the measured first level and the measured second level, i.e. the difference between the two level measurements, s_{C}_{_{—}}_{I}(x)−s_{C}(x).

However, if any one of the reference points C1 and C3 are inside the deflection bowl, the corresponding value w(x+a,x) and/or w(x−b,x) will not be zero. In this case, the stiffness of the railway track is preferably calculated first and the deflection is thereafter calculated based on the stiffness calculation.

With a straightforward definition, stiffness is force divided by displacement. Therefore, the force acting on the track due to the loaded axle needs to be measured or estimated. The simplest way, neglecting dynamic effects, is to estimate the applied force by the axle-load divided by two (two wheels on one axle). A more advanced method, still without direct measurements, would be to simulate the force with a vehicle dynamics software. As track geometry parameters (e.g. the level) are measured, these parameters could be included in the simulation to account for dynamic effects. The third way would be to actually measure the force by some kind of wheel-rail force measurement system. Several such systems exist on the market.

Consequently, according to one aspect of the invention, the method comprises the step of estimating or measuring the force, whereby the loaded axle affects the railway track.

The next step of the method is to take advantage of well known beam theory to associate the level variations along the track with the estimated or measured forces acting on the track using, for example, an Euler-Bernoulli beam model on a Winkler foundation:

$$E I \frac{{\partial }^{4} w ( x )}{d {x}^{4}} + k ( x ) w ( x ) = Q \qquad Eq . 7$$

In this equation, E, the elastic modulus, and I, the area moment of inertia, are material parameters of the beam, i.e. the rail in this case, w(x) is the deflection of the rail in the position x, k(x) is the stiffness of the supporting structure and Q(x) is the force acting on the rail.

If this differential equation is solved, the result is:

$$\begin{matrix}w ( x , {x}_{1} ) = \frac{Q ( {x}_{1} ) {L ( {x}_{1} )}^{3}}{8 EI} {e}^{- \vert x - {x}_{1} \vert / L ( {x}_{1} )} ( cos ( \frac{x - {x}_{1}}{L ( {x}_{1} )} ) + sin ( \vert \frac{x - {x}_{1}}{L ( {x}_{1} )} \vert ) ) \\ where & Eq . 9 \\ L ( x ) = \sqrt[4]{\frac{4 EI}{k ( x )}} & Eq . 10\end{matrix}$$

and x₁ is the position of the load.

Inserting the difference between the two measurements into the beam equation, i.e. inserting Eq. 9 into Eq. 5, yields:

$${s}_{C\_I} ( x ) - {s}_{C} ( x ) = \frac{b}{l} ( \begin{matrix}\frac{Q ( x ) {L ( x )}^{3}}{8 EI} {e}^{- \vert a \vert / L ( x )} ( cos ( \frac{a}{L ( x )} ) + sin ( \vert \frac{a}{L ( x )} \vert ) ) - \\ \frac{Q ( x + a ) {L ( x + a )}^{3}}{8 EI}\end{matrix} ) + \frac{a}{l} ( \begin{matrix}\frac{Q ( x ) {L ( x )}^{3}}{8 EI} {e}^{- \vert - b \vert / L ( x )} ( cos ( \frac{- b}{L ( x )} ) + sin ( \vert \frac{- b}{L ( x )} \vert ) ) - \\ \frac{Q ( x - b ) {L ( x - b )}^{3}}{8 EI}\end{matrix} ) \qquad Eq . 10$$

This is a nonlinear relationship between the parameters level, force and stiffness. This can be solved by various techniques yielding the value of the stiffness. Using a nonlinear Kalman filter is one alternative. When the stiffness variations of the track has been found, the actual deflection w(x,x1) according to Eq. 8 can easily be calculated.

Instead of the above-mentioned Euler-Bernoulli beam model, more advanced beam models including e.g. damping or a FEM (Finite Element Model) could be used. Also, if the stiffness, i.e. k, is known for a test site or by simulation, a black-box model could alternatively be used to relate the measured data, i.e. the level and the force, to the stiffness by means of system identification.

Consequently, according to one aspect of the invention, the method comprises the steps of fitting a deflection model to said calculated difference and said force and calculating the stiffness of the supporting structure from the fitted deflection model.

In the above-described example, the second measuring system is an inertia based system. Alternatively, as has been described previously, the second measuring system may also be a versine system.

If two three point versine systems are used, they may have the same central reference point, preferably at the loaded axle, but at least one of the versine systems must have at least one unique reference point in order for the systems to be able to obtain level measurements at different positions in relation to the loaded axle. For example, if the first measuring system is a 2+3 versine system as in the above-described example, the second measuring system may be a 2+1 versine system, i.e. a versine system having a first reference point 2 metres behind the loaded axle, a second reference point at the loaded axle and a third reference point 1 metre in front of the loaded axle. It is noted, that although the two versine systems share a common reference point, i.e. the point 2 metres behind the loaded axle, each system has a unique reference point, i.e. 3 metres in front of the loaded axle for the 2+3 system and 1 metre in front of the loaded axle for the 2+1 system. These unique reference points enable the two systems to measure the level at different positions. As the two systems have one or two different reference points, at least one of the systems needs to be rectified by an inverse transfer function. This is preferably done by using the technique described in “A Novel Approach for Whitening of Versine Track Geometry”, which was presented at the 21^{st} International Symposium on Dynamics of Vehicles on Roads and Tracks (IAVSD 09) in Stockholm, Sweden on Aug. 20, 2009. After the rectification, the method can proceed according to the previous description based on the inertia and versine based systems.

As described above, the method according to the invention can be used for measuring the vertical stiffness of various types of supporting structures, e.g. roads, railway tracks and airfield runways and taxiways. However, in railways, also the lateral stiffness of the track is of great importance. The lateral stiffness of a track is, inter alia, governed by the quality of the sleepers, the fasteners connecting the rail to the sleepers and the ballast which support the sleepers. If fasteners are missing or are in bad condition, and/or if the ballast does not give enough lateral support to the sleepers during a train passage, the consequences might be catastrophic with derailment as a result. It is understood that the method according to the invention can also be used to measure the lateral stiffness of a supporting structure and in particular the lateral stiffness of a railway track. However, as a force is needed to build a difference between loaded and unloaded portions of the track, the method according to the invention will only work readily in curves and transition curves where lateral forces from the loaded axle of the measuring vehicle affect the track. However, this is not a big problem, since curves and transition curves are the areas of a railway track in which the lateral stiffness particularly needs to be monitored.

1. A method for establishing the deflection and/or the stiffness of a supporting structure which is subjected to a load using a measurement vehicle comprising:
a loaded axle,
a first measuring system being a versine system comprising at least a first reference point (C1) at a predetermined first position in relation to the loaded axle, a second reference point (C2) at a predetermined second position in relation to the loaded axle and a third reference point (C3) at a predetermined third position in relation to the loaded axle, and
a second measuring system being one of:
an inertia based system which is fitted on the loaded axle, and
a versine system comprising at least a first reference point at a predetermined first position in relation to the loaded axle, a second reference point at a predetermined second position in relation to the loaded axle and a third reference point at a predetermined third position in relation to the loaded axle, wherein the position of at least one of the reference points of the two versine systems is unique to one of the versine systems;
the method comprising the steps of:
moving the measurement vehicle along the supporting structure such that the loaded axle creates a deflection bowl in the supporting structure and such that at least one of the reference points of the first measuring system and at least one of the reference points of the second measuring system is within the deflection bowl;
at a predetermined sampling rate, measuring a first set of first levels of the supporting structure using the first measuring system and a second set of second levels of the supporting structure using the second measuring system;
converting or transforming at least one of the sets of levels such that the two sets of levels relate to the same reference system and, thereafter, for each pair of sampled levels, calculating the difference between the measured first level and the measured second level, thereby eliminating the contribution to the measurements originating from unloaded irregularities in the supporting structure; and
from the calculated difference, establishing the deflection and/or the stiffness of the supporting structure.

2. The method according to claim 1, further comprising the steps of:
arranging the first (C1) and the third reference (C3) points of the first measuring system outside of a deflection bowl generated by the loaded axle; and
estimating the deflection of the supporting structure directly from said calculated difference between the measured first level and the measured second level.

3. The method according to claim 1, wherein the step of establishing the stiffness of the supporting structure comprises the steps of:
estimating or measuring the force, whereby the loaded axle affects the supporting structure;
fitting a deflection model to said calculated difference and said force, and
from the fitted deflection model, calculating the stiffness of the supporting structure.

4. The method according to claim 3, wherein said deflection model is an Euler-Bernoulli beam model on a Winkler foundation.

5. The method according to claim 3, wherein the reference points (C1-C3) of the first measuring system are arranged within a deflection bowl generated by the loaded axle.

6. The method according to claim 3, wherein the second reference point (C2) of the first measuring system is arranged at the loaded axle and that the first and the third reference points (C1, C3) of the first measuring system are arranged outside a deflection bowl generated by the loaded axle.

7. The method according to claim 3, wherein the second measuring system comprises a versine system, wherein the versine system of the first measuring system and the versine system of the second measuring system, respectively, is a three point versine measuring system, wherein the two versine measuring systems share a common reference point.

8. The method according to claim 7, wherein the common reference point is arranged at the loaded axle.

9. The method according to claim 1, wherein the first set of levels and the second set of levels, respectively, is measured in the vertical direction of the supporting structure.

10. The method according to claim 1, wherein the first set of levels and the second set of levels, respectively, is measured in the lateral direction of the supporting structure.

11. The method according to claim 1, wherein the supporting structure is a railway track.

12. The method according to claim 4, wherein the reference points (C1-C3) of the first measuring system are arranged within a deflection bowl generated by the loaded axle.

13. The method according to claim 4, wherein the second reference point (C2) of the first measuring system is arranged at the loaded axle and that the first and the third reference points (C1, C3) of the first measuring system are arranged outside a deflection bowl generated by the loaded axle.

14. The method according to claim 4, wherein the second measuring system comprises a versine system, wherein the versine system of the first measuring system and the versine system of the second measuring system, respectively, is a three point versine measuring system, wherein the two versine measuring systems share a common reference point.

15. The method according to claim 5, wherein the second measuring system comprises a versine system, wherein the versine system of the first measuring system and the versine system of the second measuring system, respectively, is a three point versine measuring system, wherein the two versine measuring systems share a common reference point.

16. The method according to claim 6, wherein the second measuring system comprises a versine system, wherein the versine system of the first measuring system and the versine system of the second measuring system, respectively, is a three point versine measuring system, wherein the two versine measuring systems share a common reference point.
